(19) United States
(12) Patent Application Publication
(10) Pub. No.: US 2001/0027397 A1
(43) Pub. Date: Oct. 4, 2001

(54) Education system with voice recognition using internet

(76) Inventor: Ku Bum Yeon, Seoul (KR)

Correspondence Address: JACOBSON, PRICE, HOLMAN & STERN, PROFESSIONAL LIMITED LIABILITY COMPANY, 400 Seventh Street, N.W., Washington, DC, 20004, US

(21) Appl. No.: 09/798,892

(22) Filed: Mar. 6, 2001

(30) Foreign Application Priority Data
Mar. 10, 2000 (KR) 2000-12005

(51) Int. Cl. G10L 11/00; G10L 21/00

(52) U.S. Cl. 704/272

(57) ABSTRACT

An education system using Internet which can improve learning effects by connecting an interactive toy appropriately responding according to information content to the Internet, and an interactive toy therefor. The toy includes a computer interface for communication with a computer in accordance with a predetermined protocol, a communication controller for interpreting data supplied from an Internet service site via the computer to output predetermined control signals, a toy speaker for outputting sound signal supplied from the computer, and a speaker selector for outputting the sound signal to either the toy speaker or the computer speaker, or both the toy speaker and the computer speaker in accordance with a speaker selection signal among the control signals output from the communication controller. Therefore, the computer, the user and the toy can interactively enhance the learning effects.

### BACKGROUND OF THE INVENTION

1. Field of the Invention

The present invention relates to an education system with voice recognition using Internet, and more particularly, to an interactive toy which adaptively responds according to the contents of Internet sites to enhance advertising or learning effects, and an Internet service system using the same.

2. Description of the Related Art

Recently, as personal computers have been in widespread use, most households have their own computers, which are, however, ineffectively used for restricted purposes, e.g., game play. In order to use computers for educational purposes, numerous education programs are being developed and sold. However, most of the education programs are simply configured such that the educational contents are displayed on the screen of a computer monitor and then sound is output via a speaker.

According to the advanced semiconductor and audio processing technology, toys that generate prestored sound have gained popularity. However, since such toys make the same sound repeatedly by the prestored sound element, children may be often led to boredom.

### SUMMARY OF THE INVENTION

To solve the above problems, it is an object of the present invention to provide an education system with voice recognition using the Internet, which can enhance the learning, or advertising effects using a toy interacting with the Internet.

To achieve the above object, there is provided an Internet service system including an Internet service site for providing predetermined services through the Internet and transceiving sound element and control data for a toy, an Internet connecting means for connecting with the Internet service site, and at least one interactive toy, connected with the Internet connecting means, moving in accordance with the control data supplied from the Internet service site and providing sound in accordance with the sound element data, whereby the toy moves or produces sound in accordance with the sound element and control data provided by the Internet service site.

According to an aspect of the present invention, there is provided an interactive toy in a service system using the Internet, an interactive toy including a computer interface for communication with a computer in accordance with a predetermined protocol, a communication controlling means for interpreting data supplied from an Internet service site via the computer to output predetermined control signals, a speaker and a decoder for decoding sound data among the data interpreted in the communication controlling means in accordance with a decoding control signal among the control signals output from the communication controlling means, converting the decoded sound data to an analog signal and outputting the converted signal to the speaker.

According to another aspect of the present invention, there is provided an interactive toy in a service system using the Internet, an interactive toy including a computer interface for communication with a computer in accordance with a predetermined protocol, a communication controlling means for interpreting data supplied from an Internet service site via the computer to output predetermined control signals, a toy speaker for outputting sound signal supplied from the computer, and a speaker selector for outputting the sound signal to either the toy speaker or the computer speaker, or both the toy speaker and the computer speaker in accordance with a speaker selection signal among the control signals output from the communication controlling means.

### BRIEF DESCRIPTION OF THE DRAWINGS

The above object and advantages of the present invention will become more apparent by describing in detail a preferred embodiment thereof with reference to the attached drawings in which:

FIG. 1 is a schematic diagram showing the structure of a service system using Internet according to the present invention;

FIG. 2 is a block diagram of an interactive toy according to an embodiment of the present invention;

FIG. 3 shows an A-type data transmission format between an interactive toy and a computer according to the present invention;

FIG. 4 shows a B-type data transmission format between an interactive toy and a computer according to the present invention; and

FIG. 5 is a block diagram of an interactive toy according to another embodiment of the present invention.

### DESCRIPTION OF THE PREFERRED EMBODIMENTS

A preferred embodiment of the present invention will now be described in detail with reference to the accompanying drawing.

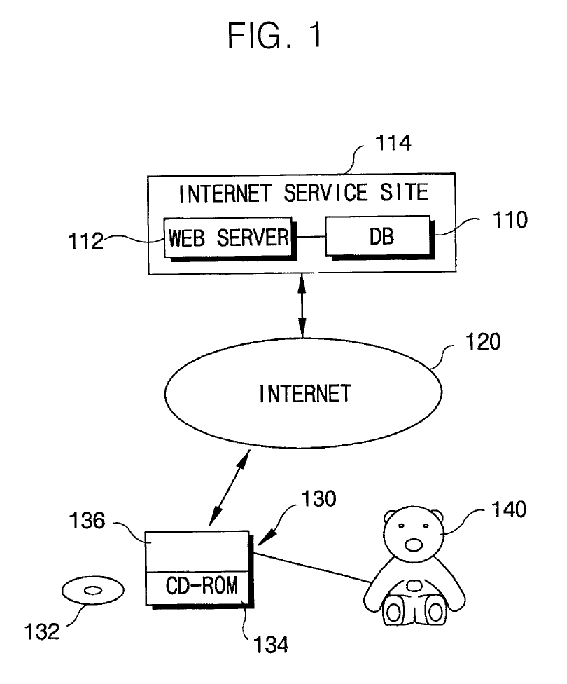

FIG. 1 is a schematic diagram showing the structure of a service system using Internet according to the present invention. The service based on the present invention can be distributed in the form of CD-ROM or transmitted from web sites of the Internet. The site providing the service via the Internet is referred to an ‘Internet service site’. In the case where the service based on the present invention is distributed in the form of CD-ROM, it is preferred that the CD-ROM is periodically distributed or sold together with an interactive toy.

Referring to FIG. 1, an Internet service site 110, including a web server 112 and a database (DB) 114, is connected to the Internet 120, and a client's personal computer (PC) 130 is also connected to the Internet 120 for utilizing the Internet service. Here, the Internet service site 110 provides a variety of services available over the Internet, such as education service, advertising service and so on, and transmits sound element data suitable for the service contents and control data to an interactive toy 140 through the Internet 120 and the PC 130. The interactive toy 140 outputs sound according to the sound element data transmitted from the Internet service site 110 or moves according to the control data.

For example, in order to use the education service according to the present invention, from the Internet service site 110, a web browser 136 is driven on the PC 130 and then connects to the Internet service site 110 for downloading a certain application program. Then, the sound element data necessary for the service is supplied from the Internet service site 110 and stored in the PC 130 or processed in real time on the downloaded application program. Here, in order to reduce a time for transmitting sound element data through the Internet 120, the sound element data is not downloaded whenever connecting to the Internet service site 110 but is downloaded only when the data of the site 110 is different from the data stored in the PC 130 based on the result of checking the version. In the case of using the Internet service site 110 as described above, it is easy to update the service contents according to necessity. Also, the user can be presented with the data provided by the Internet service site 110 in real time concurrently in a state where the user connects the Internet, thereby utilizing on-line learning and advertisement.

In the case of distributing the service based on the present invention in the form of CD-ROM 132, a desired service can be rendered using a CD-ROM drive 134 installed in the PC 130, without connecting to the Internet 120.

The PC 130 displays contents (characters, figures or images) on the monitor according to the service received through the CD-ROM 132 or the Internet 120 and outputs the sound conformable to the contents through the speaker. Also, the control data for controlling the moving of the interactive toy 140 and the data of voice to be produced by the interactive toy 140 are packed in a predetermined format and transmitted to the interactive toy 140 by wire using a MIDI (Musical Instrument Digital Interface) port, a RS (Recommended Standard)-232C port, a USB (Universal Serial Bus) port, a parallel port and the like. The user's manipulation signal is received from the interactive toy 140 to then be transmitted to the Internet service site 110, thereby performing an appropriate operation.

The interactive toy 140 moves its arms, legs or head according to the control data received from the Internet service site 110 via the PC 130, and outputs sound according to the voice data. Also, when the user touches it, the toy 140 detects the fact, and transmits the same to the Internet service site 110 via the PC 130. Also, the interactive toy 140 may alert the state of the computer according to the data received from the PC 130, display the alerted content or produce voice.

As described above, according to the present invention, a personal computer, an interactive toy and a user can interactively enhance the learning and advertising effects according to the service contents. In particular, like in today's households, that is, mostly ones having only one child, the interactive toy 140 actively participates in the education program as a third party for child education to induce child interest, thereby increasing the learning effects. Also, according to the service content, the toy may be fabricated in various shapes, e.g., bear, human, monkey, puppy, cat, duck, ball and so on, or may be implemented in various ways in view of movement or responses of the toy. The interactive toy 140 has a predetermined frame, e.g., a bear-shaped frame, and includes an electronic circuit embedded therein for movement and sound.

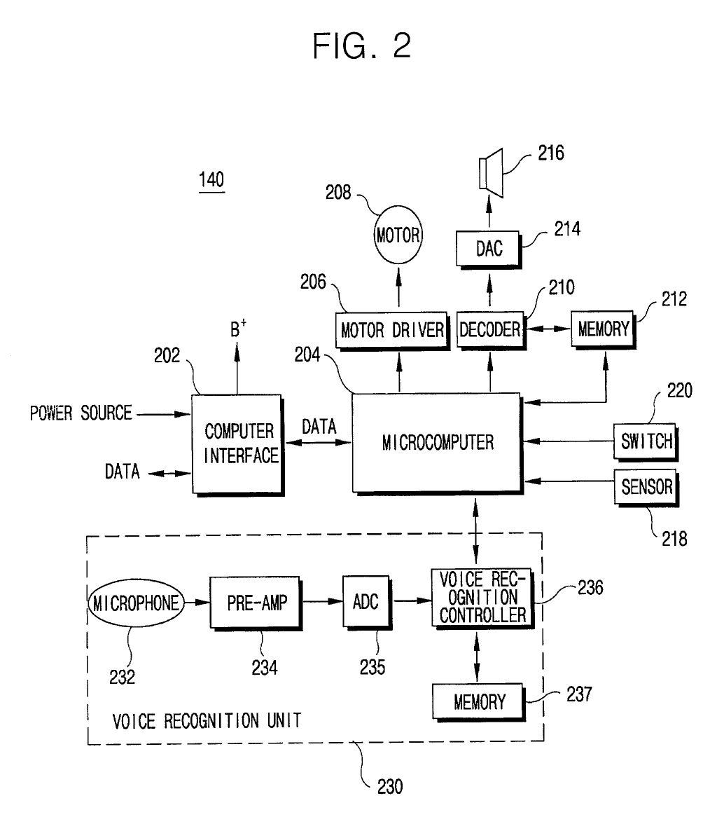

Then, in reference with FIG. 2, an operation of the interactive toy 140 according to an embodiment of the present invention will be explained in detail.

In FIG. 2, the interactive toy 140 includes a computer interface 202, a microcomputer 204, a motor driver 206, a motor 208, a decoder 210, a memory 212, a digital-to-analog converter (DAC) 214, a speaker 216, a sensor 218, a switch 220, a voice recognition unit 230. The voice recognition unit 230 includes a microphone 232, a pre-amplifier 234, an analog-to-digital converter (ADC) 235, a voice recognition controller 236 and a memory 237. Here, the voice recognition unit 230 is an optional component that can be added into the interactive toy 140 according to the need of the voice recognition function.

Referring to FIG. 2, the computer interface 202 is a portion for connecting the computer (130 of FIG. 1) with the interactive toy 140 by wire, and may take various forms according to a computer port. A power source for driving the interactive toy 140 may be a separate battery, a power supply from an adapter or a power supply from the computer 130. In the case of using the computer power supply, the power is preferably supplied through the computer interface 202.

The motor 208 is installed at a joint part of the interactive toy 140, that is, at a portion at which movement is required, and causes the arms, legs, head or waist of the toy to move. The motor driver 206 supplies a driving signal for driving the corresponding motor according to the movement command input from the microcomputer 204. As an actuator for causing the movement to the toy 140, another means such as a solenoid as well as the motor can be used.

The decoder 210 decodes the voice data stored in the memory 212 or transmitted in real time according to the control of microcomputer 204. The DAC 214 converts digital voice data into an analog signal and then outputs the same to the speaker 216 to generate sound. The memory 212 stores its own sound element or voice data transmitted from the Internet service site 110. In the case of using the own sound element (that is, a prestored sound element), the sound element designated according to the index input from the Internet 120 is provided.

The switch 220 turns on/off the operation of the toy 140. The sensor 218, installed on requested parts of the interactive toy 140, e.g., arms, belly or head, detects the user's manipulation, and supplies the detection signal to the microcomputer 204.

The voice recognition unit 230 recognizes the voice made by the user to control the corresponding toy operation. The microphone 232 converts the user's voice into an electrical signal. The pre-amplifier 234 amplifies the electrical signal of the microphone 232. The ADC 235 converts an analog voice signal into a digital signal. The voice recognition controller 236 compares the voice database stored in the memory 237 with the voice data input through the microphone 232, recognizes the voice and then supplies the comparison result to the microcomputer 204. Although the voice recognition controller 236 and the memory 237 may be incorporated in a computer 130 by software, they are mounted in the toy in the present invention.

As will be described later, the microcomputer 204 communicates with the PC 130 based on a predetermined communication protocol, outputs a movement command to the motor driver 206 according to the control data received from the PC 130, stores the received voice data in the memory 212, and then instructs the decoder 210 to perform decoding or supplies the index to cause the sound element stored in the memory 212 to be decoded. Also, the microcomputer 204 controls the movement of the toy 140 according to the detection signal received from the switch 220 or the sensor 218, or makes the detection signal into a packet having a predetermined format to transmit the packet to the PC 130. Further, if the recognition result is received from the voice recognition unit 230, the microcomputer 204 transmits the received recognition result to the PC 130, or controls the movement and sound of the toy 140.

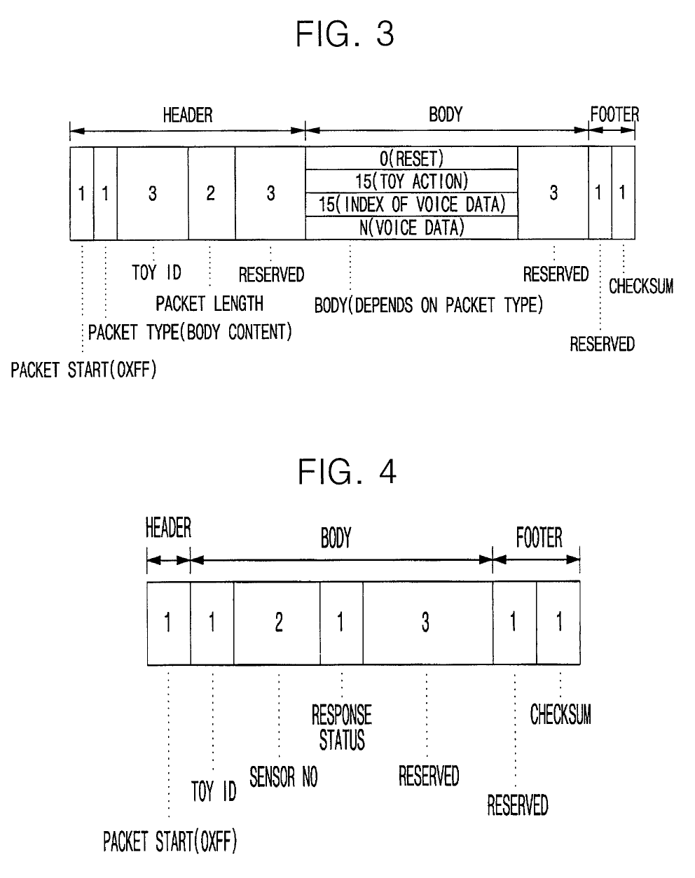

FIGS. 3 and 4 show an example of the communication protocol between the PC 130 and the interactive toy 140 according to the present invention.

According to the communication protocol of the present invention, a data transmission format is divided into an A-type format transmitted from the PC 130 to the toy 140 and a B-type format transmitted from the toy 140 to the PC 130. The A-type format is subdivided into reset, toy action, index of voice data and voice data according to the body content.

The A-type data transmission format, as shown in FIG. 3, is divided into a header, a body and a footer. The header includes a packet start region, a packet type region, a toy ID region, a packet length region and a reserved region. The packet start code of the header indicates the start of a packet and the packet type code is for differentiating various body types. The toy ID code designates a toy responding in the case where a plurality of toys are connected to one computer. The length of the body varies according to the contents. In the case of a reset, toy action, index of voice data and voice data, the lengths of body are 0 byte, 15 bytes, 15 bytes, and N bytes, respectively. Also, 3-byte reserved region is contained in the body region. The footer includes a 1-byte reserved region and a 1-byte checksum region.

The B-type data transmission format, as shown in FIG. 4, is divided a 1-byte header, 7-byte body, and 2-byte footer. The body is subdivided into a toy ID region, a sensor No. region, a response status, and a reserved region. The toy ID designates a toy responding in the case where a plurality of toys are connected to one computer. The sensor No. is for differentiating a sensor manipulated by a user. The response status is for expressing the intensity of a sensor manipulated by a user and response time. The footer is divided into a 1-byte reserved region and a 1-byte checksum region.

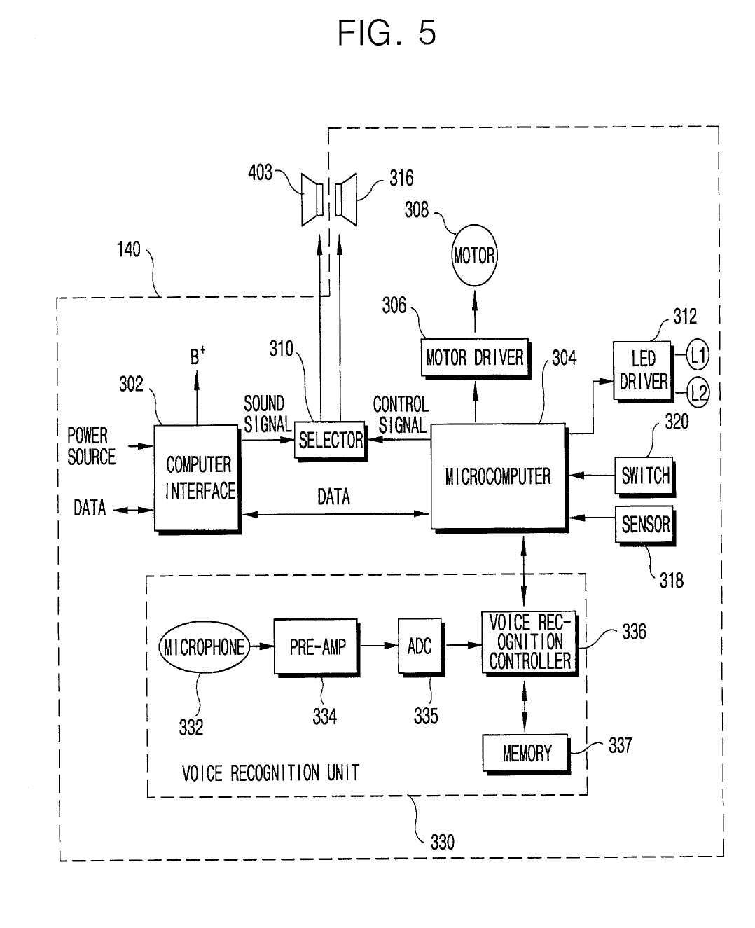

FIG. 5 shows an interactive toy 140 according to another embodiment of the present invention. The interactive toy 140 includes a computer interface 302, a microcomputer 304, a motor driver 306, a motor 308, a speaker selector 310, a light emitting diode (LED) driver 312, a first LED L1, a second LED L2, a speaker 316, a sensor 318, a switch 320, and a voice recognition unit 330. The voice recognition unit 330 includes a microphone 332, a pre-amplifier 334, an analog-to-digital converter (ADC) 335, a voice recognition controller 336 and a memory 337. Reference numeral 403 denotes a speaker of the PC 130. Similarly, the voice recognition unit 330 is an optional component that can be added into the interactive toy 140 according to the need of the voice recognition function.

The difference between the interactive toy 140 shown in FIG. 5 and the interactive toy 140 of FIG. 2 is that the speaker selector 310 is used for providing the sound signal from the computer interface 302 to both the toy speaker 316 and the computer speaker 403 instead of the decoder 210 and the DAC 214 for processing the voice data provided from the microcomputer 204. Accordingly, the detailed explanation of the computer interface 302, the microcomputer 304 and the speaker selector 310 will be given.

Referring to FIG. 5, the computer interface 202 is a portion for connecting the computer (130 of FIG. 1) with the interactive toy 140 by wire, and may take various forms according to a computer port. Similarly, a power source for driving the interactive toy 140 may be a separate battery, a power supply from an adapter or a power supply from the computer 130. In the case of using the computer power supply, the power is preferably supplied through the computer interface 202. Meanwhile, the sound signal is separately included in the signal provided from the computer interface 302, compared to the toy 140 according to the first embodiment in FIG. 2.

The microcomputer 304, as will be described later, communicates with the PC 130 based on a predetermined communication protocol, outputs a movement command to the motor driver 306 according to the control data received from the PC 130, outputs an LED driving command to the LED driver 312, or outputs a speaker selection command to the speaker selector 310. Also, the microcomputer 304 controls the movement of the toy 140 according to the detection signal received from the switch 320 or the sensor 318 or makes the detection signal into a packet in a predetermined format to then transmit the packet to the PC 130. Further, if the recognition result is received from the voice recognition unit 330, the microcomputer 304 transmits the received recognition result to the PC 130, or controls the movement and sound of the toy 140.

The speaker selector 310, generally consisting of a relay, supplies a voice signal supplied from the computer interface 302 to either the toy speaker 316 or the computer speaker 403, or both the toy speaker 316 and the computer speaker 403 according to a control signal corresponding to the speaker selection command output from the microcomputer 304.

The LED driver 312 drives the first and second LEDs L1 and L2, generally fixed to the body of the toy 140, for example, left and right eyes, according to a control signal corresponding to the LED driving command output from the microcomputer 304. Here, another means such as a light source may be used instead of the LEDs.

Table 1 shows an example of a body of A-type data transmission format in a communication protocol now being used between the PC 130 and the interactive toy 140 of FIG. 5 according to the present invention.

TABLE 1

| DEC | HEX | Content |
|---|---|---|
| 0 | 00 | Reserved |
| 1 | 01 | Version check |
| 2 | 02 | Initialize toy to MIDI mode and check connection to toy |
| 3 | 03 | Computer speaker ON |
| 4 | 04 | Toy speaker ON |
| 5 | 05 | Computer and toy speakers ON |
| 6 | 06 | Mouth movement ON |
| 7 | 07 | Mouth movement OFF |
| 8 | 08 | Arm movement ON |
| 9 | 09 | Arm movement OFF |
| 10 | 0a | Mouth and arm movement ON |
| 11 | 0b | Mouth and arm movement OFF |
| 12 | 0c | L1 ON |
| 13 | 0d | L1 OFF |
| 14 | 0e | L2 ON |
| 15 | 0f | L2 OFF |
| 16 | 10 | L1 and L2 ON |
| 17 | 11 | L1 and L2 OFF |

As shown in Table 1, the communication protocol between the PC 130 and the toy 140, that is, A-type and B-type data transmission formats may consist of 1-byte header, 1-byte body and 1-byte footer, respectively. That is, only 1-byte suffices for the body region since the operations to be expressed by the toy 140 are a few and the sound signal for the toy 140 is directly provided to the toy speaker 316 from the computer 130 via the speaker selector 310.

As described above, according to the present invention, education and advertising services are rendered such that a toy that connects to the Internet through a personal computer, reacts according to contents, and a user manipulates the toy to allow the toy and the computer, thereby enhancing the learning and advertising effects by the interaction among the user, computer and toy. In particular, the toy offers the sound and movement adaptive to services of various contents supplied from Internet service sites, which induces user's interest, thereby increasing the learning and advertising effects. Further, since the power source of the computer is used, batteries are not necessarily replaced. Also, a variety of responses can be caused through voice recognition, further increasing the learning and advertising effects.

While this invention has been described in connection with what is presently considered to be the most practical and preferred embodiments, it is to be understood the invention is not limited to the disclosed embodiments, but, on the contrary, it is intended to cover various modifications and equivalent arrangements about the format of the communication protocol, the kind of the sensor, the number of the LED etc. within the spirit and scope of the appended claims in consideration of the specification and drawings.

What is claimed is:

1. An Internet service system comprising;
an Internet service site for providing predetermined services through the Internet and transceiving sound element and control data for a toy;
an Internet connecting means for connecting with the Internet service site; and
at least one interactive toy, connected with the Internet connecting means, moving in accordance with the control data supplied from the Internet service site and providing sound in accordance with the sound element data, whereby the toy moves or produces sound in accordance with the sound element and control data provided by the Internet service site.

2. The Internet service system according to claim 1, wherein the Internet connecting means and the interactive toy are connected by wire.

3. The Internet service system according to claim 2, wherein the Internet connecting means is a computer and an interface port for the interactive toy is one of a MIDI (Musical Instrument Digital Interface) port, a RS (Recommended Standard)-232C port, a USB (Universal Serial Bus) port and a parallel port.

4. In a service system using the Internet, an interactive toy comprising:
a computer interface for communication with a computer in accordance with a predetermined protocol;
a communication controlling means for interpreting data supplied from an Internet service site via the computer to output predetermined control signals;
a speaker; and
a decoder for decoding sound data among the data interpreted in the communication controlling means in accordance with a decoding control signal among the control signals output from the communication controlling means, converting the decoded sound data to an analog signal and outputting the converted signal to the speaker.

5. The interactive toy according to claim 4, further comprising at least one sensor for sensing user's manipulation and supplying a detection signal to the communication controlling means to form data corresponding to the user's manipulation.

6. The interactive toy according to claim 5, further comprising:
at least one actuator for causing the toy to move; and
an actuator driving means for driving the corresponding actuator in accordance with a movement command signal among the control signals output from the communication controlling means.

7. The interactive toy according to claim 6, further comprising a voice recognition unit for recognizing user's voice and outputting the recognition result to the communication controlling means, whereby allowing the toy to respond according to the user's voice.

8. The interactive toy according to claim 4, configured to use a power source of the computer provided through the computer interface.

9. The interactive toy according to claim 4, configured to use either a power source of the computer provided through the computer interface or an embedded battery.

10. The interactive toy according to claim 4, configured to display the notifying or alerting the status of a computer in accordance with the data supplied from the computer and to produce voice.

11. In a service system using the Internet, an interactive toy comprising:
a computer interface for communication with a computer in accordance with a predetermined protocol;
a communication controlling means for interpreting data supplied from an Internet service site via the computer to output predetermined control signals; and
a toy speaker for outputting sound signal supplied from the computer.

12. The interactive toy according to claim 11, further comprising a speaker selector for outputting the sound signal to either the toy speaker or the computer speaker, or both the toy speaker and the computer speaker in accordance with a speaker selection signal among the control signals output from the communication controlling means.

13. The interactive toy according to claim 12, further comprising a light emitting diode (LED) driver for driving at least one LED in accordance with an LED driving command signal among the control signals output from the communication controlling means.

14. The interactive toy according to claim 13, further comprising at least one sensor for sensing user's manipulation and supplying a detection signal to the communication controlling means to form data corresponding to the user's manipulation.

15. The interactive toy according to claim 14, further comprising:
at least one actuator for causing the toy to move; and
an actuator driving means for driving the corresponding actuator in accordance with a movement command signal among the control signals output from the communication controlling means.

16. The interactive toy according to claim 15, further comprising a voice recognition unit for recognizing user's voice and outputting the recognition result to the communication controlling means, whereby allowing the toy to respond according to the user's voice.

17. The interactive toy according to claim 11, configured to use a power source of the computer provided through the computer interface.

18. The interactive toy according to claim 11, configured to use either a power source of the computer provided through the computer interface or an embedded battery.

19. The interactive toy according to claim 11, configured to display the notifying or alerting the status of a computer in accordance with the data supplied from the computer and to produce voice.
